(19) United States
(12) Patent Application Publication
(10) Pub. No.: US 2026/0280455 A1
(43) Pub. Date: Sep. 17, 2026

(54) METHOD FOR DETERMINING ROTATION PARAMETERS OF A ROTATION ANGLE, AND ELECTRIC MOTOR

(71) Applicant: Schaeffler Technologies AG & Co. KG, Herzogenaurach (DE)

(72) Inventors: Dr. Erhard HODRUS, Achern (DE); Christian EBERLE, Buhl (DE); Alexander ROSCH, Achern (DE)

(73) Assignee: Schaeffler Technologies AG & Co. KG, Herzogenaurach (DE)

(21) Appl. No.: 19/469,514

(22) PCT Filed: Feb. 28, 2024
(86) PCT No.: PCT/DE2024/100160

§ 371 Date: Sep. 26, 2025

(30) Foreign Application Priority Data
Mar. 28, 2023 (DE) 10 2023 107 740.6

(51) Int. Cl. H02P 6/16; H02P 23/00; H02P 23/14

(52) U.S. Cl. CPC H02P 6/16; H02P 23/0077; H02P 23/14

(57) ABSTRACT

A method for determining rotation parameters of at least one variable rotation angle (γ) of a rotor of an electric motor, said angle dependent on a rotational speed (ω), the method comprising the following steps: determining a first phase voltage (u_{d}) and a first phase current (i_{d}) each with respect to a d-direction, and a second phase voltage (u_{q}) and a second phase current (i_{q}) each with respect to a q-direction of the rotor-fixed dq-coordinate system; applying a calculation algorithm with an iterative calculation of the rotational speed (ω) as the calculated rotational speed (ωᵢ) and the rotational angle (γ) as the calculated rotational angle (γᵢ); outputting the calculated rotational angle (γᵢ) as the output calculated rotation angle (γᵣ); and calculating the rotational speed (ω) as the output calculated rotational speed (ωᵣ) from the output calculated rotation angle (γᵣ), without directly calculating the calculated rotational speed (ωᵢ).

### CROSS-REFERENCE TO RELATED APPLICATIONS

This application is the U.S. National Phase of PCT Appln. No. PCT/DE2024/100160, filed Feb. 28, 2024, which claims the benefit of German Patent Appln. No. 102023107740.6, filed Mar. 28, 2023, the entire disclosures of which are incorporated by reference herein.

### TECHNICAL FIELD

The disclosure relates to a method for determining rotation parameters and to an electric motor.

### BACKGROUND

When the rotor of an electric motor rotates and thus sufficient counter-induced voltage is available, in the case of permanent magnet synchronous motors, it is known to use a method on the basis of a voltage model according to voltage equations of the electrical phase voltages to determine rotation parameters. The phase voltages are firstly measured and then calculated as modeled phase voltages using the voltage model. This voltage model also includes the electrical phase currents and electrical motor parameters. Voltage errors in the dq-coordinate system are calculated from the difference between the measured and the modeled phase voltage. The rotation angle and rotational speed are calculated by reducing the voltage errors.

In M. Brodatzki, J. Richter, J. Kolb and M. Braun, “Position and Speed Estimation Algorithm for Permanent Magnet Synchronous Machines Considering Nonlinear Magnetic Effects,” 10th International Conference on Power Electronics and ECCE Asia (ICPE 2019—ECCE Asia), 2019, pp. 1-8, an iterative calculation is described which, in one calculation step, starts from a solution for the rotation angle and the rotational speed from the preceding calculation step and calculates four voltage errors in the d-direction and q-direction by changing the rotation angle and the rotational speed. By applying the two-dimensional secant method, the calculated rotation angle and the calculated rotational speed are calculated as a solution to the nonlinear system of equations of the voltage model.

If the motor parameters used in the voltage model are assumed incorrectly, for example due to temperature influences, an incorrect and/or delayed calculation of the calculated rotation angle and of the calculated rotational speed may occur.

ICHIKAWA, Shinji [inter alia]: Sensorless controls of salient-pole permanent magnet synchronous motors using extended electromotive force models, in: Electrical Engineering in Japan, vol. 146, 2004, No. 3, pp. 55-64,—ISSN 0424-7760 (P); 1520-6416 (E), DOI: 10.1002/eej, 10257, URL: https://onlinelibrary.wiley.com/doi/epdf/10.1002/eej.10257 [accessed 2024 Feb. 7], describes a mathematical model for synchronous motors and a sensorless control method based on it, which enables rotor position determination without approximation.

### SUMMARY

An object of the present disclosure is to determine the rotation parameters of the electric motor more precisely, easily and quickly.

At least one of these objects is achieved by a method for determining rotation parameters having the features disclosed herein. This allows the rotation angle to be determined more precisely and quickly. Model inaccuracies in the voltage model can be better compensated for. The calculation of the rotation angle and/or the rotational speed can be more independent of temperature influences.

The electric motor can be arranged in a vehicle. The vehicle can be a motor vehicle. The electric motor can provide drive power to move the vehicle and/or drive power to operate a vehicle component. The vehicle component can be an auxiliary unit, in particular a fluid pump. The fluid pump can be a hydraulic pump.

The electric motor can be operated in an encoderless mode. The method can be carried out during an encoderless mode of the electric motor. The electric motor can be operated exclusively in an encoderless mode. Encoderless mode is understood to mean a mode without incorporating a rotation angle measured by a sensor, for example a position sensor.

The electric motor can be controlled via at least three motor phases. The electric motor can be a brushless direct current motor. The electric motor can be an AC synchronous motor with permanent magnets.

The output calculated rotational speed can be calculated as a time-dependent change in the output calculated rotation angle.

The modeled first phase voltage and the modeled second phase voltage can be calculated using a voltage model. The modeled first phase voltage u_{d,m} can be calculated according to the first phase current i_{d} and the second phase current i_{q} as follows:

$${u}_{d , m} = {R}_{s} {i}_{d} + {L}_{d} \frac{d {i}_{d}}{d t} - ω {L}_{q} {i}_{q}$$

with the directional inductances L_{d}, L_{q} and the electrical resistance Rₛ of the stator as electrical motor parameters P.

The modeled second phase voltage u_{q,m} can be calculated using the voltage model as follows:

$${u}_{q , m} = {R}_{s} {i}_{q} + {L}_{q} \frac{d {i}_{q}}{d t} + ω ( {L}_{d} {i}_{d} + {Ψ}_{E M} )$$

with the flux linkage Ψ_{EM} of the rotor as an additional motor parameter P′.

The first and second phase voltages in the dq-coordinate system can be calculated from the phase voltages in the stator-fixed coordinate system. The electric motor can have three motor phases. The phase voltages in the stator-fixed coordinate system can therefore form three phase voltages.

The output as an output calculated rotation angle can be the output from the calculation algorithm.

The output calculated rotational speed can be calculated directly as the change in the output calculated rotation angle over time.

The output calculated rotation angle and/or the output calculated rotational speed can be used to control a rotary operation of the electric motor, in particular in a current control system.

In a preferred embodiment of the disclosure, it is advantageous if an output of the calculated rotational speed for calculating the output calculated rotational speed is omitted. The calculated rotational speed can only be used for internal calculation in the calculation algorithm. The output of the calculated rotational speed may refer to an output from the calculation algorithm, in particular after completion of the iterative calculation.

In a preferred embodiment of the disclosure, the first and/or second phase voltage is/are determined by means of estimation from a current control system of the first and second phase current. As a result, the method can be carried out more cost-effectively. The first and/or second phase voltage can be determined alternatively or additionally by measuring the corresponding phase voltage.

The first and/or second phase voltage can be measured directly or indirectly.

According to the disclosure, the calculation algorithm uses a first relationship that specifies a first voltage difference between the determined first phase voltage and the modeled first phase voltage. The first relationship can specify the first voltage difference Δu_{d} according to the determined first phase voltage u_{d} and the modeled first phase voltage u_{d,m} as follows:

$$Δ {u}_{d} = {u}_{d} - {u}_{d , m}$$

According to the disclosure, the rotation angle is calculated iteratively using the first relationship in that the rotation angle γᵢ₋₁ calculated previously in a preceding calculation step is used and changed in a calculation step by a rotation angle difference Δγ in such a way that the first voltage difference is reduced. The iterative calculation of the rotation angle to reduce the first voltage difference Δu_{d} can be implemented by iteratively adjusting the rotation angle with the following dependency:

$$Δ {u}_{d} = f ( {ω}_{i - 1} , {γ}_{i - 1} \pm Δ γ )$$

In a particular embodiment of the disclosure, it is advantageous if the reduction in the first voltage difference is achieved exclusively by iterative adjustment of the rotation angle. An iterative adjustment in the rotational speed, in particular by introducing a rotational speed difference, can be omitted.

In a particular embodiment of the disclosure, it is advantageous if the calculation algorithm uses a second relationship which specifies a second voltage difference between the determined second phase voltage and the modeled second phase voltage. The second relationship can specify the second voltage difference Δu_{q} according to the determined second phase voltage u_{q} and the modeled second phase voltage u_{q,m} as follows:

$$Δ {u}_{q} = {u}_{q} - {u}_{q , m}$$

In a particular embodiment of the disclosure, it is advantageous if the iterative calculation of the rotational speed is carried out using the second relationship in that the rotational speed previously calculated in a preceding calculation step ωᵢ₋₁ is used and changed in a calculation step by a rotational speed difference Δω in such a way that the second voltage difference Δu_{q} is reduced. The iterative calculation of the rotational speed can be implemented by iteratively adjusting the rotational speed with the following dependency:

$$Δ {u}_{q} = f ( {ω}_{i - 1} \pm Δ ω , {γ}_{i - 1} )$$

If the additional motor parameter P′ used in the modeled second phase voltage u_{q,m} is temperature-dependent and not precisely known or is unknown during the rotary operation of the rotor, the iterative calculation with the second relationship by iteratively adjusting the calculated rotational speed ωᵢ can cause a reduction in the second voltage difference, and the resulting calculated rotational speed ωᵢ in the first relationship can be used to calculate the calculated rotation angle.

The calculated rotational speed can thus be used as an internally calculated rotational speed to compensate for uncertainties in the additional motor parameters P′. The calculation algorithm can compensate for possible model uncertainties caused by unknown changes in motor parameters, such as the additional engine parameters P′.

If the additional engine parameter P′ is imprecise, for example, the iterative calculation can still find an equilibrium with the second relationship if the rotational speed is adjusted in the opposite direction to the change in the additional motor parameter by the iterative calculation. If the additional motor parameter P′ is smaller, for example, the iterative calculation will calculate a larger rotational speed. This property of finding an equilibrium with the second relationship can be exploited when feeding back the rotational speed for the next calculation step of the iterative calculation.

In an advantageous embodiment of the disclosure, the reduction in the second voltage difference is achieved exclusively by iterative adjustment of the rotational speed. An iterative adjustment of the rotation angle, in particular by introducing a rotation angle difference, can be omitted.

Furthermore, within the scope of the disclosure, an electric motor is disclosed to achieve at least one of the above-mentioned objects. This allows the electric motor to be operated more conveniently and efficiently.

Further advantages and advantageous embodiments of the disclosure are apparent from the description of the figures and the drawings.

### BRIEF DESCRIPTION OF THE DRAWINGS

The disclosure is described in detail below with reference to the drawings. In the drawings, in particular:

FIG. 1: shows an electric motor in a particular embodiment of the disclosure.

FIG. 2: shows a method for determining rotation parameters in a particular embodiment of the disclosure.

### DETAILED DESCRIPTION

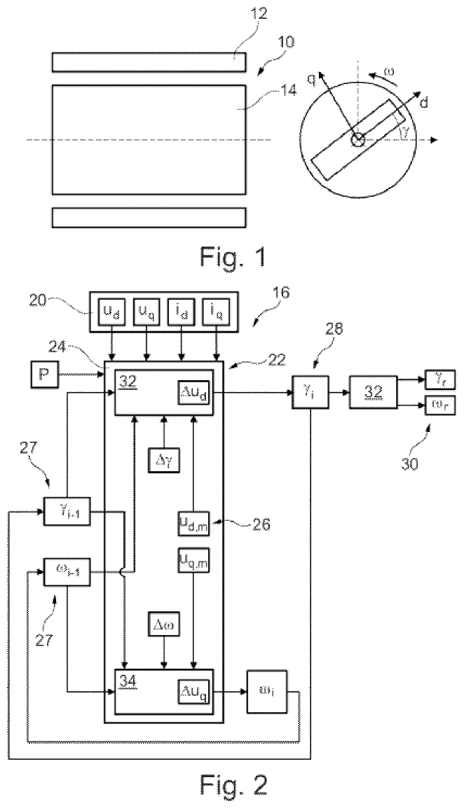

FIG. 1 shows an electric motor in a particular embodiment of the disclosure. The electric motor 10 comprises a stator 12 and a rotor 14 which can be rotated in relation to said stator by changing a rotation angle γ. During rotary operation, the rotor 14 has a rotational speed ω which changes the rotation angle γ. The electrical variables, such as a phase voltage or a phase current, can be specified in the rotor-fixed dq-coordinate system.

FIG. 2 shows a method for determining rotation parameters in a particular embodiment of the disclosure. The method 16 for determining rotation parameters is used during rotary operation of the electric motor, for example as shown in FIG. 1, in which the rotor is rotated relative to the stator by changing the rotation angle γ according to the rotational speed ω of the rotor. The method 16 comprises the steps:
determining 20 a first phase voltage u_{d} and a first phase current i_{d} in each case with respect to a d-direction and a second phase voltage u_{q} and a second phase current i_{q} in each case with respect to a q-direction of the rotor-fixed dq-coordinate system,
using 22 a calculation algorithm 24 with a calculation 26 of the first phase voltage u_{d} as a modeled first phase voltage u_{d,m} and the second phase voltage u_{q} as a modeled second phase voltage u_{q,m} at least according to the first and second phase current i_{d}, i_{q}, at least one electrical motor parameter P, the rotational speed ω and the rotation angle γ,
iteratively calculating 27 the rotational speed ω as a calculated rotational speed ωᵢ and the rotation angle γ as a calculated rotation angle γᵢ according to the modeled first and second phase voltage u_{d,m}, u_{q,m},
outputting 28 the calculated rotation angle γᵢ as an output calculated rotation angle γᵣ and
calculating 30 the rotational speed ω as an output calculated rotational speed ωᵣ from the output calculated rotation angle γᵣ without directly calculating from the calculated rotational speed ωᵢ.

The calculated rotational speed ωᵢ is therefore used exclusively internally to calculate the calculated rotation angle γᵢ. An output of the calculated rotational speed ωᵢ to calculate 30 the output calculated rotational speed ωᵣ is therefore omitted.

The first and second phase voltage u_{d}u_{q} can be estimated from a current control system of the first and second phase current i_{d}, i_{q}.

In the calculation algorithm 24, a first relationship 32 is used, which specifies a first voltage difference Δu_{d} between the determined first phase voltage u_{d} and the modeled first phase voltage u_{d,m}, and a second relationship 34 is used, which specifies a second voltage difference Δu_{q} between the determined second phase voltage u_{q} and the modeled second phase voltage u_{q,m}.

The iterative calculation 27 of the rotation angle γ takes place with the first relationship 32 in that the rotation angle γᵢ₋₁ calculated previously in a preceding calculation step is used and changed in the current calculation step by a rotation angle difference Δγ in such a way that the first voltage difference Δu_{d} is reduced. The reduction in the first voltage difference Δu_{d} is achieved in particular exclusively by iteratively adjusting the rotation angle γᵢ. An iterative adjustment of the rotational speed ωᵢ is omitted in the process.

The iterative calculation 27 of the rotational speed ω takes place with the second relationship 34 in that the rotational speed ωᵢ₋₁ calculated previously in a preceding calculation step is used and is changed in the current calculation step by a rotational speed difference Δω in such a way that the second voltage difference Δu_{q} is reduced. The reduction in the second voltage difference Δu_{q} is achieved in particular exclusively by iteratively adjusting the rotational speedo). An iterative adjustment of the rotation angle γᵢ is omitted in the process.

The output calculated rotational speed ωᵣ and the output calculated rotation angle γᵣ can be calculated from the calculated rotation angle γᵢ using a filter 32.

### LIST OF REFERENCE SIGNS

10 Electric motor
12 Stator
14 Rotor
16 Method
20 Determination
22 Use
24 Calculation algorithm
26 Calculation
27 Iterative calculation
28 Output
30 Calculation
32 First relationship
34 Second relationship
P Electrical motor parameter
Δu_{d} First voltage difference
Δu_{q} Second voltage difference
Δγ Rotation angle difference
Δω Rotational speed difference
γ Rotation angle
γᵢ Calculated rotation angle
γᵣ Output calculated rotation angle
γᵢ₋₁ Previously calculated rotation angle
ω Rotational speed
ωᵢ Calculated rotational speed
ωᵣ Output calculated rotational speed
ωᵢ₋₁ Previously calculated rotational speed
i_{d} First phase current
i_{q} Second phase current
u_{d} First phase voltage
u_{q} Second phase voltage
u_{d,m} Modeled first phase voltage
u_{q,m} Modeled second phase voltage

1. A method for determining rotation parameters of at least rotation angle (γ), which is variable according to a rotational speed (ω), of a rotor of an electric motor which is rotatable relative to a stator, comprising the following steps:
determining a first phase voltage (u_{d}) and a first phase current (i_{d}) in each case with respect to a d-direction and a second phase voltage (u_{q}) and a second phase current (i_{q}) in each case with respect to a q-direction of a rotor-fixed dq-coordinate system,
using a calculation algorithm with a calculation of the first phase voltage (u_{d}) as a modeled first phase voltage (u_{d,m}) and the second phase voltage (u_{q}) as a modeled second phase voltage (u_{q,m}) at least according to the first and second phase current (i_{d}, i_{q}), at least one electrical motor parameter (P), the rotational speed (ω) and the rotation angle (γ) and with an iterative calculation of the rotational speed (ω) as a calculated rotational speed (ωᵢ) and the rotation angle (γ) as a calculated rotation angle (γᵢ) according to the determined first and second phase voltage (u_{d}, u_{q}) and the modeled first and second phase voltage (u_{d,m}, u_{q,m}),
outputting the calculated rotation angle (γᵢ) as an output calculated rotation angle (γᵣ) and
calculating the rotational speed (ω) as an output calculated rotational speed (ωᵣ) from the output calculated rotation angle (γᵣ) without directly calculating from the calculated rotational speed (ωᵢ),
wherein
the calculation algorithm uses a first relationship which specifies a first voltage difference (Δu_{d}) between the determined first phase voltage (u_{d}) and the modeled first phase voltage (u_{d,m}), and
the iterative calculation of the rotation angle (γ) with the first relationship is carried out in that a rotation angle (γᵢ₋₁) calculated previously in a preceding calculation step is used and is changed in a calculation step by a rotation angle difference (Δγ) to reduce the first voltage difference (Δu_{d}).

2. The method according to claim 1, wherein an output of the calculated rotational speed (ωᵢ) for calculating the output calculated rotational speed (ωᵣ) is omitted.

3. The method according to claim 1, wherein the determination of at least one of the first or second phase voltage (u_{d}, u_{q}) takes place by estimation from a current control system of the first and second phase current (i_{d}, i_{q}).

4. The method according to claim 1, wherein the reduction in the first voltage difference (Δu_{d}) is achieved exclusively by iteratively adjusting the rotation angle (γᵢ).

5. The method according to claim 1, wherein the calculation algorithm uses a second relationship which specifies a second voltage difference (Δu_{q}) between the determined second phase voltage (u_{q}) and the modeled second phase voltage (u_{q,m}).

6. The method according to claim 5, wherein the iterative calculation of the rotational speed (ω) takes place with the second relationship in that a rotational speed (ωᵢ₋₁) calculated previously in a preceding calculation step is used and is changed in a calculation step by a rotational speed difference (Δw) to reduce the second voltage difference (Δu_{q}).

7. The method according to claim 6, wherein the reduction in the second voltage difference (Δu_{q}) is achieved exclusively by iterative adjustment of the rotational speed (ωᵢ).

8. An electric motor comprising a stator and a rotor which is rotatable relative to the stator by changing a rotation angle (γ) and has a rotation angle (γ) that can be determined by determining rotation parameters with a calculation algorithm including:
determining a first phase voltage (u_{d}) and a first phase current (i_{d}) in each case with respect to a d-direction and a second phase voltage (u_{q}) and a second phase current (i_{q}) in each case with respect to a q-direction of a rotor-fixed dq-coordinate system,
using a calculation algorithm with a calculation of the first phase voltage (u_{d}) as a modeled first phase voltage (u_{d,m}) and the second phase voltage (u_{q}) as a modeled second phase voltage (u_{q,m}) at least according to the first and second phase current (i_{d}, i_{q}), at least one electrical motor parameter (P), the rotational speed (ω) and the rotation angle (γ) and with an iterative calculation of the rotational speed (ω) as a calculated rotational speed (ωᵢ) and the rotation angle (γ) as a calculated rotation angle (γᵢ) according to the determined first and second phase voltage (u_{d}, u_{q}) and the modeled first and second phase voltage (u_{d,m}, u_{q,m}),
outputting the calculated rotation angle (γᵢ) as an output calculated rotation angle (γr) and
calculating the rotational speed (ω) as an output calculated rotational speed (ωᵣ) from the output calculated rotation angle (γᵣ) without directly calculating from the calculated rotational speed (ωᵢ),
wherein
the calculation algorithm uses a first relationship which specifies a first voltage difference (Δu_{d}) between the determined first phase voltage (u_{d}) and the modeled first phase voltage (u_{d,m}), and
the iterative calculation of the rotation angle (γ) with the first relationship is carried out in that a rotation angle (γᵢ₋₁) calculated previously in a preceding calculation step is used and is changed in a calculation step by a rotation angle difference (Δγ) to reduce the first voltage difference (Δu_{d}).

9. The electric motor according to claim 8, wherein an output of the calculated rotational speed (ωᵢ) for calculating the output calculated rotational speed (ωᵣ) is omitted.

10. The electric motor according to claim 8, wherein the determination of at least one of the first or second phase voltage (u_{d}, u_{q}) takes place by estimation from a current control system of the first and second phase current (i_{d}, i_{q}).

11. The electric motor according to claim 8, wherein the reduction in the first voltage difference (Δu_{d}) is achieved exclusively by iteratively adjusting the rotation angle (γᵢ).

12. The electric motor according to claim 8, wherein the calculation algorithm uses a second relationship which specifies a second voltage difference (Δu_{q}) between the determined second phase voltage (u_{q}) and the modeled second phase voltage (u_{q,m}).

13. The electric motor according to claim 12, wherein the iterative calculation of the rotational speed (ω) takes place with the second relationship in that a rotational speed (ωᵢ₋₁) calculated previously in a preceding calculation step is used and is changed in a calculation step by a rotational speed difference (Δω) to reduce the second voltage difference (Δu_{q}).

14. The electric motor according to claim 13, wherein the reduction in the second voltage difference (Δu_{q}) is achieved exclusively by iterative adjustment of the rotational speed (ωᵢ).
